(19) United States
(12) Patent Application Publication
(10) Pub. No.: US 2025/0320857 A1
(43) Pub. Date: Oct. 16, 2025

(54) MULTIPLE CRYOGENIC PUMP ASSEMBLY FOR HYDROGEN FUELING STATION

(71) Applicants: Robert Bosch GmbH, Stuttgart (DE); FirstElement Fuel Inc., Irvine, CA (US); Bosch Rexroth Corporation, Mt. Prospect, IL (US)

(72) Inventors: Tim Brown, San Juan Capistrano, CA (US); Joshua Adams, Aliso Viejo, CA (US); Alexander G. Murashko, JR., Webster, NY (US); Nicolas Englert, Lohr a. Main (DE); Thomas Knoblach, Gemünden (DE); Timote Bednarz, Lohr am Main (DE); Dominik Ebert, Hammelburg (DE); Philipp Bergmann, Lohr am Main (DE); Markus Perschall, Aschaffenburg (DE); Royce Gerngross, Cypress, TX (US); Andreas Günder, Ramsthal (DE); Marc Weigand, Hafenlohr (DE)

(21) Appl. No.: 18/636,141

(22) Filed: Apr. 15, 2024

(51) Int. Cl. F04B 37/08; F04B 27/00; F17C 7/02

(52) U.S. Cl. CPC F04B 37/08; F04B 27/005; F17C 7/02; F17C 2221/012; F17C 2227/015; F17C 2265/065

(57) ABSTRACT

A hydrogen fueling station includes a cryogenic pump with a cold end portion base plate and a cylindrical insulated vacuum jacket attached to the cold end portion base plate and extending away from the cold end portion base plate. Two hydrogen pump cylinders are positioned in parallel within the cylindrical insulated vacuum jacket. A first hydraulic cylinder is positioned outside of the cylindrical insulated vacuum jacket and aligned with the first hydrogen pump cylinder with the cold end portion base plate positioned between the first hydraulic cylinder and the first hydrogen pump cylinder. A second hydraulic cylinder is located outside of the cylindrical insulated vacuum jacket and adjacent to, and oriented parallel to, the first hydraulic cylinder and aligned with the second hydrogen pump cylinder with the cold end portion base plate positioned between the second hydraulic cylinder and the second hydrogen pump cylinder.

Cross-reference is made to U.S. Utility patent application Ser. No. 18/636,132 entitled “CRYOGENIC PUMP FOR HYDROGEN FUELING STATION WITH LONG STROKE” by Brown et al., which was filed on Apr. 15, 2024; U.S. Utility patent application Ser. No. [Attorney Docket No. 1576-2899] entitled “CRYOGENIC PUMP WITH INVERSE ORIENTATION FOR HYDROGEN FUELING STATION” by Brown et al., which was filed on Apr. 15, 2024; U.S. Utility patent application Ser. No. [Attorney Docket No. 1576-2900] entitled “CRYOGENIC PUMP FOR HYDROGEN FUELING STATION” by Brown et al., which was filed on Apr. 15, 2024; and U.S. Utility patent application Ser. No. [Attorney Docket No. 1576-2901] entitled “CRYOGENIC PUMP WITH DESIGNED LEAKBY FOR HYDROGEN FUELING STATION” by Brown et al., which was filed on Apr. 15, 2024, the entirety of each of which is incorporated herein by reference. The principles of the present invention may be combined with features disclosed in those patent applications.

### FIELD

The present disclosure relates generally hydrogen fueling stations, and more particularly to a cryogenic pump used in a hydrogen fueling station.

### BACKGROUND

Fuel cells have shown promise as an alternative power source for vehicles and other transportation applications. Fuel cells operate with a renewable energy carrier, such as hydrogen. Fuel cells also operate without toxic emissions and greenhouse gases. In order to resupply a vehicle operating with a fuel cell which uses hydrogen as the renewable energy carrier hydrogen is stored in a fluid form at a hydrogen fueling station.

Hydrogen fueling stations for vehicles can store bulk hydrogen as a liquid at a pressure of 0 to 5 barg and a temperature of 18 to 25K. (Note: “barg” refers to gage pressure in units of bar). In order to dispense the stored liquid hydrogen to hydrogen-fueled vehicles, the hydrogen is transitioned to a gaseous state at a high pressure of 700 to 1000 barg and a temperature of −40 to −20 deg C. (233 to 253K).

The transition from liquid to gaseous hydrogen in some systems effected with the aid of a dual stage pumping system. In a first stage the liquid hydrogen is “supercooled” by increasing the pressure of the fluid with a first stage pump. The temperature of the supercooled hydrogen is increased from the initial temperature due to the working of the first stage pump. Additionally, the temperature of the supercooled liquid hydrogen increases as a result of heat gain from the atmosphere. The increased pressure provided by the first stage pump ensures the hydrogen fluid stays in a fluid form as it is heated. A second stage pump is then used to further increase pressure with incumbent increase in temperature.

The two-stage approach described above is typically limited by the physical constraints of liquid hydrogen entering the first stage of the pumping system. In particular, since the bulk liquid hydrogen is kept close to its triple point so as to reduce costs associated with storing the liquid hydrogen, the bulk liquid hydrogen is easily vaporized with only a slight increase in temperature or reduction of pressure. Consequently, even the presence of a valve between the bulk storage tank and the first stage pump which creates a small pressure drop as the liquid hydrogen flows into the suction of a first stage pump can be sufficient to flash the bulk hydrogen to vapor which makes pumping of the hydrogen problematic.

The problem of vaporization is further exacerbated by any gain of energy from the piping between the bulk storage tank and the first stage suction since even a slight increase in temperature can cause vaporization of the bulk liquid hydrogen. Accordingly, in many applications the bulk liquid hydrogen is gravity fed into the suction of the first stage pump. Alternatively, the bulk hydrogen may be further cooled as it exits the bulk storage tank.

In order to minimize energy transfer into the liquid hydrogen as it moves thorough the first and second pumping stages a single drive rod is typically used to drive both the first stage and second stage pumps. While effective in reducing the amount of energy put into the liquid hydrogen, the mechanical coupling required in this type of apparatus causes the first stage pump to be operated at a mass flow rate exceeding the capacity of the second stage pump. This results in inefficiency in the system since the excess hydrogen must be removed from the outlet of the first stage pump. The excess hydrogen may be released into the atmosphere, burned, or fed back into the bulk storage tank.

Other issues arise with known systems due to the orientation of the systems. In systems wherein a pump is submerged in a liquid hydrogen bath, any vaporized hydrogen migrates to the uppermost areas of the pumps, which can be problematic since the pumps are not as effective at moving vaporized hydrogen, the second stage outlet of known systems is generally located at the bottom of the pumps. Consequently, the motor and drive shaft of the pump are normally located at the upper side of the pump. This configuration, while effective in guarding against vaporization within the pump, makes the pump top-heavy and thus inherently unstable.

In an attempt to ameliorate stability issues, some systems have been developed with substantially horizontally oriented power shafts. While effective in providing increased stability, horizontally oriented systems place unequal pressure on pump seals since the pump shafts are substantially horizontally oriented thereby generating uneven wear and increased friction and heat.

What is needed is a system which reduces one or more of the heating and or stability issues discussed above.

### SUMMARY

According to one embodiment of the present disclosure, a hydrogen fueling station includes a cryogenic pump with a cold end portion base plate. In some embodiments, the cryogenic pump isa second stage cryogenic pump. A cylindrical insulated vacuum jacket is attached to the cold end portion base plate and extends away from the cold end portion base plate. A first and a second hydrogen pump cylinder are positioned within the cylindrical insulated vacuum jacket. The second hydrogen pump cylinder is oriented parallel to the first hydrogen cylinder. A first hydraulic cylinder positioned outside of the cylindrical insulated vacuum jacket is aligned with the first hydrogen pump cylinder with the cold end portion base plate positioned between the first hydraulic cylinder and the first hydrogen pump cylinder. A second hydraulic cylinder is located outside of the cylindrical insulated vacuum jacket and adjacent to, and oriented parallel to, the first hydraulic cylinder and is aligned with the second hydrogen pump cylinder with the cold end portion base plate positioned between the second hydraulic cylinder and the second hydrogen pump cylinder.

In one or more embodiments, a portion of a supply header extends through the cold end portion base plate. The portion of the supply header is in fluid communication with the first hydrogen pump cylinder and the second hydrogen pump cylinder. A portion of a discharge header extends through the cold end portion base plate. The portion of the discharge header is in fluid communication with the first hydrogen pump cylinder and the second hydrogen pump cylinder.

In one or more embodiments, a hydrogen fueling station further includes a first and a second junction located within the cylindrical insulated vacuum jacket. The portion of the supply header is in fluid communication with the first hydrogen pump cylinder through the first junction and a first supply feed line. The portion of the supply header is in fluid communication with the second hydrogen pump cylinder through the first junction and a second supply feed line. The portion of the discharge header is in fluid communication with the first hydrogen pump cylinder through the second junction and a first discharge line. The portion of the discharge header is in fluid communication with the second hydrogen pump cylinder through the second junction and a second discharge line.

In one or more embodiments, the first discharge line and the second discharge line are crossed at a crossing location within the cylindrical insulated vacuum jacket whereat the first hydrogen pump cylinder and the second hydrogen pump cylinder are located between the crossing location and the cold end portion base plate.

In one or more embodiments the first hydrogen pump cylinder has a first cylinder head, and the second hydrogen pump cylinder has a second cylinder head. The first supply feed line is in fluid communication with the first hydrogen pump cylinder through the first cylinder head and the first discharge line is in fluid communication with the first hydrogen pump cylinder through the first cylinder head. The second supply feed line is in fluid communication with the second hydrogen pump cylinder through the second cylinder head, and the second discharge line is in fluid communication with the second hydrogen pump cylinder through the second cylinder head.

In one or more embodiments a first inlet check valve is located within the first cylinder head. The first inlet check valve includes a poppet seat made from a metal material and a seal made from a polymer. The first supply feed line is in fluid communication with the first hydrogen pump cylinder through the first inlet check valve.

In one or more embodiments, at least a portion of the portion of the supply header within the cylindrical insulated vacuum jacket is formed from flex piping.

In one embodiment a cryogenic pump includes a cold end portion base plate. A cylindrical insulated vacuum jacket is attached to the cold end portion base plate and extends away from the cold end portion base plate. A first and a second hydrogen pump cylinder are positioned within the cylindrical insulated vacuum jacket. The second hydrogen pump cylinder is oriented parallel to the first hydrogen cylinder piston. A first hydraulic cylinder is positioned outside of the cylindrical insulated vacuum jacket and aligned with the first hydrogen pump cylinder with the cold end portion base plate positioned between the first hydraulic cylinder and the first hydrogen pump cylinder. A second hydraulic cylinder is located outside of the cylindrical insulated vacuum jacket and adjacent to, and oriented parallel to, the first hydraulic cylinder and aligned with the second hydrogen pump cylinder with the cold end portion base plate positioned between the second hydraulic cylinder and the second hydrogen pump cylinder.

In one ore more embodiments, a cryogenic pump includes a supply header portion extending through the cold end portion base plate and in fluid communication with the first hydrogen pump cylinder and the second hydrogen pump cylinder, and a discharge header portion extending through the cold end portion base plate and in fluid communication with the first hydrogen pump cylinder and the second hydrogen pump cylinder.

In one or more embodiments, a cryogenic pump includes a first junction located within the cylindrical insulated vacuum jacket and fluidically connecting the supply header portion with a first supply feed line which is in fluid communication with the first hydrogen pump cylinder, and fluidically connecting the supply header portion with a second supply feed line which is in fluid communication with the second hydrogen pump cylinder. A second junction is located within the cylindrical insulated vacuum jacket and fluidically connects the discharge header portion with the first hydrogen pump cylinder through a first discharge line, and fluidically connects the discharge header portion with the second hydrogen pump cylinder through a second discharge line.

In one or more embodiments of a cryogenic pump, the first discharge line and the second discharge line are crossed at a crossing location within the cylindrical insulated vacuum jacket whereat the first hydrogen pump cylinder and the second hydrogen pump cylinder are located between the crossing location and the cold end portion base plate.

In one or more embodiments of a cryogenic pump, the first hydrogen pump cylinder has a first cylinder head and the second hydrogen pump cylinder has a second cylinder head. The first supply feed line is in fluid communication with the first hydrogen pump cylinder through the first cylinder head. The first discharge line is in fluid communication with the first hydrogen pump cylinder through the first cylinder head. The second supply feed line is in fluid communication with the second hydrogen pump cylinder through the second cylinder head. The second discharge line is in fluid communication with the second hydrogen pump cylinder through the second cylinder head.

In one or more embodiments of a cryogenic pump, a first inlet check valve is located within the first cylinder head. The first inlet check valve includes a poppet seat made from a metal material and a seal made from a polymer. The first supply feed line is in fluid communication with the first hydrogen pump cylinder through the first inlet check valve.

In one or more embodiments of a cryogenic pump at least a portion of the supply header portion within the cylindrical insulated vacuum jacket is formed from flex piping.

### BRIEF DESCRIPTION OF THE DRAWINGS

The above-described features and advantages, as well as others, will become more readily apparent to those of ordinary skill in the art by reference to the following detailed description and accompanying drawings.

FIG. 1 is a simplified schematic depiction of a hydrogen fueling station that is used to provide hydrogen to a vehicle;

FIG. 2 depicts a side perspective view of the second stage pump of FIG. 1 including an explosive containment enclosure positioned on a cold end portion of the second stage pump;

FIG. 3 depicts a side perspective view of the warm end portion of the second stage pump of FIG. 1 showing two independently controlled hydraulic pumps which drive two mechanically decoupled hydraulic pistons;

FIG. 4 depicts a side cut-open view of the warm end portion of the second stage pump of FIG. 2;

FIG. 5 depicts a side cut-open view of the second stage pump of FIG. 2;

FIG. 6 depicts a perspective view of the intermediate portion of the second stage pump of FIG. 2 with access port covers removed;

FIG. 7 depicts a cross-sectional view of a seal box between the intermediate and cold end portion of the second stage pump of FIG. 2;

FIG. 8 depicts a perspective cross-sectional view of a seal assembly of the seal component of FIG. 7;

FIG. 9 depicts a perspective cross-sectional view of the seal component of FIG. 7;

FIG. 10 depicts a side perspective view of the ice scraper of FIG. 7;

FIG. 11 depicts a bottom perspective view of the seal component of FIG. 7;

FIG. 12 depicts a partial cross-sectional view of the cold end portion of the second stage pump of FIG. 2 including the cold end portion base plate and seal box portions;

FIG. 13 depicts a partial cross-sectional view of the cold end portion of the second stage pump of FIG. 2 including blow by seals;

FIG. 14 depicts a partial cross-sectional view of the cold end portion of the second stage pump of FIG. 2 including a pump cap and cylinder head;

FIG. 15 depicts a perspective view of the cold end portion of the second stage pump of FIG. 2 including the pump caps and cylinder heads;

FIG. 16 depicts a perspective view of the cold end portion of the second stage pump of FIG. 2 with the vacuum jacket removed;

FIG. 17 depicts a cross-sectional view of a cylinder head of the second stage pump of FIG. 2;

FIG. 18 depicts a simplified schematic view of a control system for the hydrogen fueling station of FIG. 1;

FIG. 19 depicts a phase diagram used by the controller of FIG. 18;

FIG. 20 depicts a side cut-open view of the second stage pump of FIG. 2 at the beginning of a return stroke for one of the hydrogen pump cylinders with the hydrogen pump cylinder, thermal decoupling cylinder, and hydraulic cylinders aligned;

FIG. 21 depicts a side cut-open view of the second stage pump of FIG. 2 at the beginning of a power stroke for the hydrogen pump cylinders of FIG. 20;

FIG. 22 depicts a cross-sectional view of a portion of a hydrogen piston and hydrogen pump cylinder showing a spacing between the hydrogen piston and the hydrogen pump cylinder; and

FIG. 23 depicts a schematic diagram of a hydraulic system incorporating the warm end portion of FIG. 3.

### DETAILED DESCRIPTION

For the purpose of promoting an understanding of the principles of the disclosure, reference will now be made to the embodiments illustrated in the drawings and described in the following written description. It is to be understood that no limitation to the scope of the disclosure is thereby intended. It is further to be understood that the present disclosure includes any alterations and modifications to the illustrated embodiments and includes further applications of the principles of the disclosure as would normally occur to one skilled in the art to which this disclosure pertains.

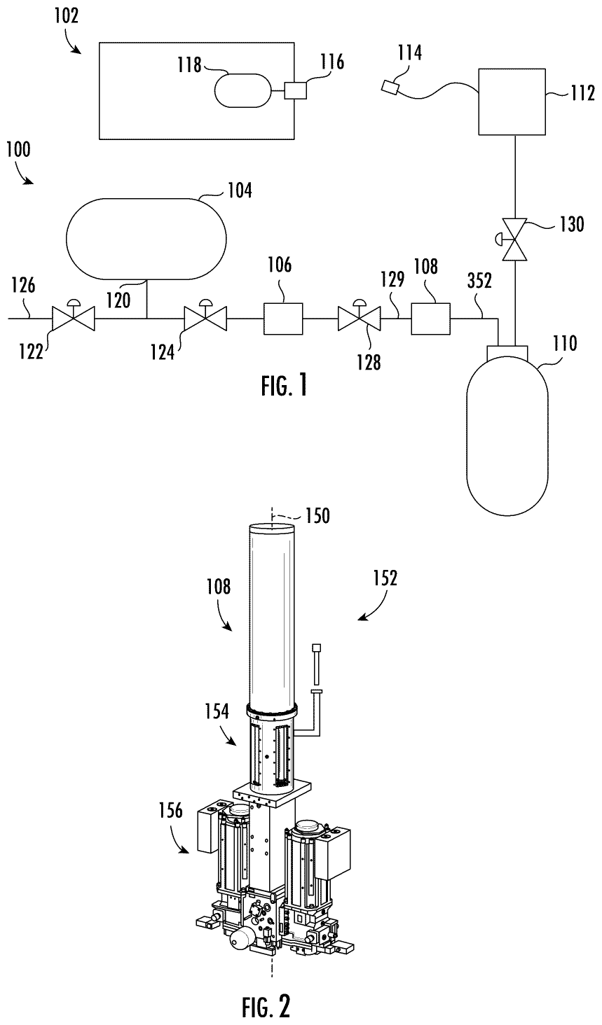

FIG. 1 is a simplified schematic depiction of a hydrogen fueling station 100 that is used to provide hydrogen to a vehicle 102. The hydrogen fueling station 100 includes a bulk storage tank 104, a first stage pump 106, a second stage pump 108, a ready storage tank 110, and a dispensing unit 112. The dispensing unit 112 includes a nozzle 114 which is used to couple with a receiver 116 of the vehicle 102 to fill a hydrogen tank 118 of the vehicle 102. In some embodiments the ready storage tank is omitted.

The bulk storage tank 104 is configured to store liquid hydrogen at a pressure of 0 to 5 barg and a temperature of 18 to 25° K. The bulk storage tank 104 includes at least one port 120 which is used to supply liquid hydrogen to, and/or provide liquid hydrogen from, the bulk storage tank 104. Isolation valves 122 and 124 are used to selectively connect the port 120 to a supply line 126 or an input side of the first stage pump 106. In some embodiments, more than one first stage pump is provided in parallel with the first stage pump 106 to provide a desired flow rate. Another isolation valve 128 is provided on the first stage supply header 129 between the first stage pump 106 and the second stage pump 108. Isolation valve 130 is provided between the ready storage tank 110 and the dispensing unit 112. More or fewer valves may be incorporated into the system as desired for a particular configuration.

The second stage pump 108, which is used to provide hydrogen to the ready storage tank 110 in a gaseous state at a high pressure of 400 to 950 barg and a temperature of −40 to −20 degrees C. (233 to 253K), or higher, is shown in further detail in FIG. 2. The second stage pump 108 defines an axis 150 which is aligned with a vertical axis when installed in the hydrogen fueling station 100. In other embodiments, the axis is aligned with a direction other than vertical. The second stage pump 108 includes a cold end portion 152, an intermediate portion 154, and a warm end portion 156 including a hydraulic system 157.

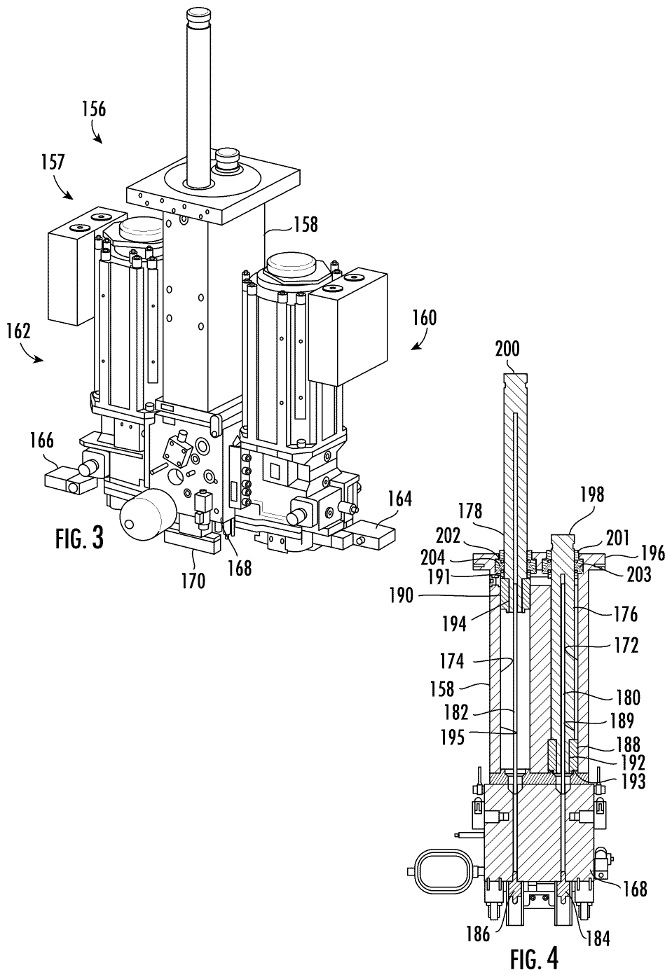

The hydraulic system 157, also shown in FIGS. 3 and 4, includes a hydraulic cylinder housing 158 positioned between two hydraulic motor pump assemblies 160 and 162. Since the hydraulic components account for about ¾ of the weight of the second stage pump 108, positioning the hydraulic components at the bottom of the second stage pump 108 inherently stabilizes the second stage pump 108. Power and control signals for the hydraulic motor pump assemblies 160 and 162 are provided through electronic connectors 164 and 166, respectively. In some embodiments, a single pump unit is used.

A manifold 168, which in this embodiment is a swashplate manifold, includes a hydraulic swashplate manifold connector 170 located beneath the hydraulic cylinder housing 158 and includes a swashplate (discussed below) which sequentially hydraulically connects the hydraulic motor pump assemblies 160 and 162 to hydraulic cylinders 172 and 174 (see FIG. 4) within the hydraulic cylinder housing 158. The hydraulic cylinders 172 and 174 are cross-connected within the swashplate manifold 168 such that following a power stroke using the hydraulic cylinder 174, hydraulic fluid within the hydraulic cylinder 174 is used to supply hydraulic fluid to the hydraulic motor pump assemblies 160/162 for use in a power stroke within the hydraulic cylinder 172. Likewise, following a power stroke using the hydraulic cylinder 172, hydraulic fluid within the hydraulic cylinder 172 is used to supply hydraulic fluid to the hydraulic motor pump assemblies 160/162 for use in a power stroke within the hydraulic cylinder 174.

Two hydraulic pistons 176 and 178 are located partially within the hydraulic cylinders 172 and 174, respectively. The hydraulic pistons 176 and 178 in one embodiment are formed from austenitic stainless steel. Two high precision transducers 180 and 182 are respectively positioned within the hydraulic pistons 176 and 178 and provide respective piston position signals through respective position terminals 184 and 186.

Piston seals 188 and 190 are provided on bottom portions 192 and 194, respectively, of the hydraulic pistons 176 and 178. The piston seals 188/190 divide the hydraulic cylinders 172 and 174 into upper low-pressure portions 189/191 above the piston seals 188/190 and high-pressure portions 193/195 below the piston seals 188/190. the volumes of the low-pressure portions 189/191 and the high-pressure portions 193/195 vary based upon the position of the piston seals 188/190.

The hydraulic pistons 176 and 178 extend through hydraulic seals 201/202 in a hydraulic top plate 196. The hydraulic seals 201/202 include respective drain lines 203/204 for draining any leakage of hydraulic fluid out of the hydraulic cylinders 172/174. The hydraulic pistons 176 and 178 include upper end portions 198 and 200, respectively, which are located within the intermediate portion 154 (see FIG. 2).

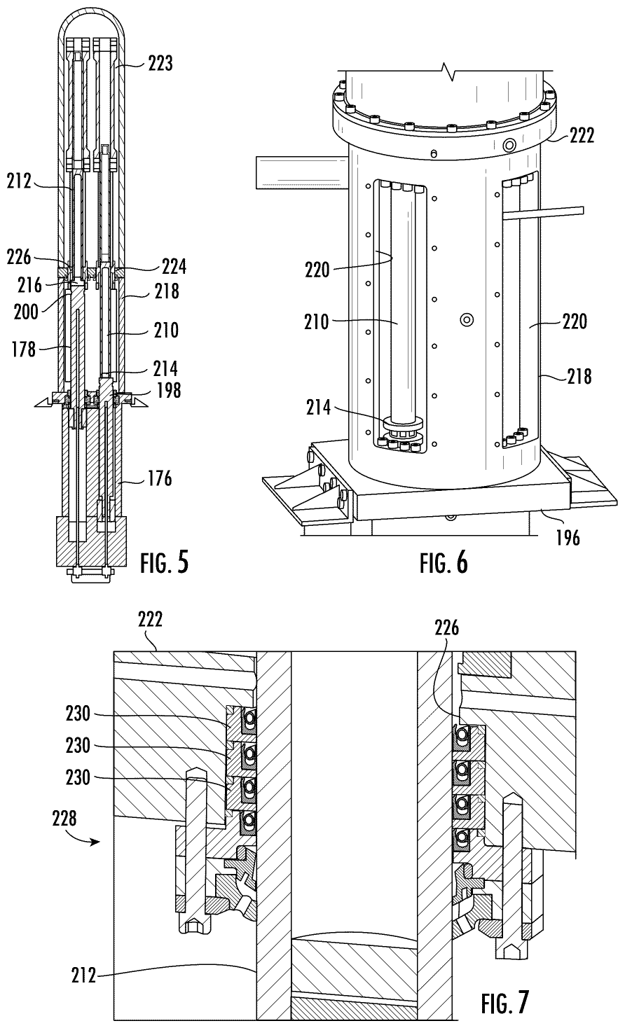

As shown in FIGS. 5-6, the upper end portions 198 and 200 are fixedly connected to thermal decoupling rods 210 and 212, respectively, by couplers 214 and 216, respectively, within an intermediate portion housing 218. The intermediate portion housing 218 is shown with covers (not shown) removed to reveal access ports 220, shown most clearly in FIG. 6. The access ports 220 allow access within the intermediate portion housing 218 to facilitate coupling the upper end portions 198 and 200 to the thermal decoupling rods 210 and 212 as well as to facilitate coupling the intermediate portion housing 218 to the hydraulic top plate 196. The access ports 220 further provide access for fastening the intermediate portion housing 218 to a cold end portion base plate 222 to which an insulated vacuum jacket 223 is attached.

The cold end portion base plate 222 includes two through holes 224 and 226 (see FIG. 5) which include respective seal box portions 228 which are described with reference to the seal box portion 228, shown in FIG. 7, for the through hole 226. The seal box portion 228 holds at least one seal assembly 230 (three are shown in the embodiment of FIG. 7) one of which is shown in FIG. 8. The seal assembly 230 includes a holder portion 232 with an outer groove 234 and an inner groove 236. A seal component 238 is positioned within the inner grove 236 and includes a body portion 240, a groove 242, and a sealing lip 244. The body portion 240 in one embodiment is formed from a material which is impervious to hydrogen, which maintains flexibility at cryogenic temperatures, which exhibits good wear, and which is tribologically engineered for contact with the material of the thermal decoupling rods in non-lubricated service.

An outer elastomeric ring 246 is located within the outer groove 234 and sized to be compressed between the holder portion 232 and the seal box portion 228 when the seal assembly 230 is positioned within the seal box portion 228. An inner spring component 248 is located within the groove 242. The seal lip 244 is sized to be placed into tension by the thermal coupling rod 212 while expansion of the seal 238 in the area of the seal lip 244 by the thermal coupling rod 212 places the inner spring component 248 into compression.

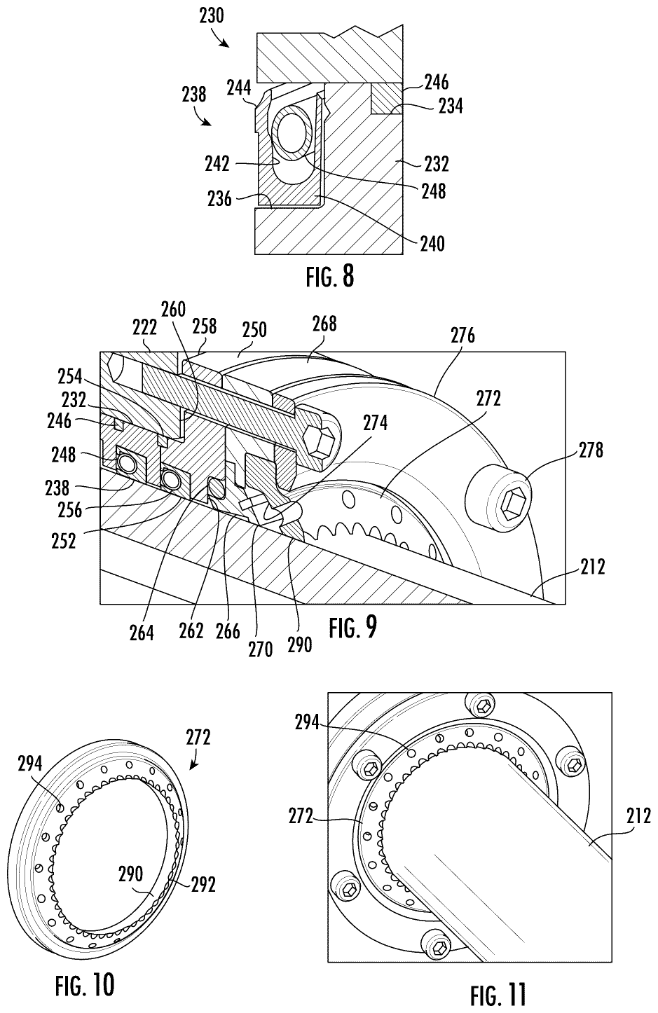

With reference to FIG. 9, a further holder portion 250 is shaped to hold a seal component 252, which is identical to the seal component 238, and an outer elastic ring 254. An inner spring component 256 is located within the seal component 252. The holder portion 250 differs from the holder portion 232 in that the holder portion 250 includes a lip 258 which extends over a bottom surface 260 of the cold end portion base plate 222. The holder portion 250 further includes an inner groove 262 which receives an O-ring 264.

The O-ring 264 compresses a rear portion of a scraper component 266 against the thermal coupling rod 212. The scraper component 266 is further positioned by a seal holder 268 and includes a seal lip 270. The scraper 266 is spaced apart from an ice scraper 272 by a cavity 274. The ice scraper 272 is held in position by the seal holder 268 and by a screw ring 276 which clamps the seal holder 268 and holder portion 250 against the bottom surface 260 of the base plate 222 by tightening of screws 278.

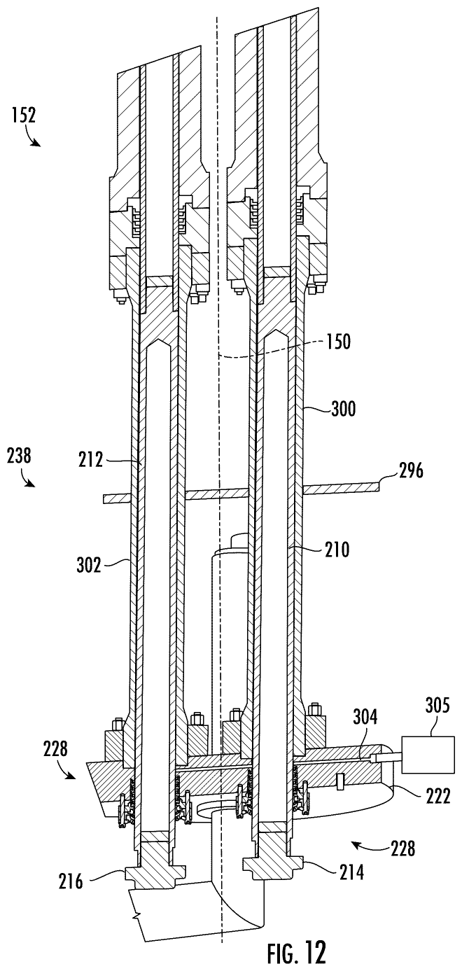

The ice scraper 272, which is also shown in FIGS. 10 and 11, includes an inner surface 290 configured to slidingly engage the thermal coupling rod 212. A lower edge 292 of the ice scraper 272 is scalloped. The scalloping does not, however, extend completely across the inner surface 290 as shown most clearly in FIGS. 9 and 10. A number of holes 294 extend completely through the ice scraper 272 and provide a communication path to the cavity 274.

With reference to FIG. 12, the thermal decoupling rods 210 and 212 extend through the seal box portion 228 and the cold end portion base plate 222 into respective thermal decoupling cylinders 300/302. The thermal decoupling cylinders 300/302 are fixedly connected at their lower ends to the cold end portion base plate 222. Pressure within the thermal decoupling cylinders 300/302 is maintained by a vent line 304 which extends through the cold end portion base plate 222. One or more baffle plates 296 are positioned about the thermal decoupling cylinders 300/302. The baffle plates 296 extend to the insulated vacuum jacket 223 and interrupt convection currents within the insulated vacuum jacket 223. In some embodiments, the baffle plates are curved or angled with respect to the vertical axis 150. In some embodiments, the baffle plates are non-structural members. In other embodiments, the baffle plates 296 further provide stiffening.

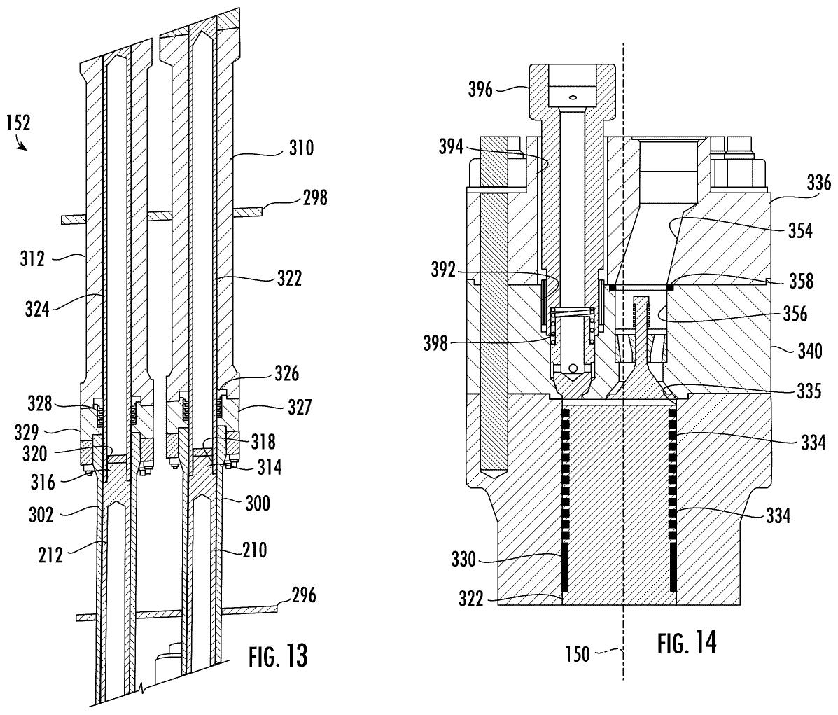

The upper portions of the thermal decoupling cylinders 300/302 are fixedly connected to hydrogen pump cylinders 310 and 312, respectively, as shown in FIG. 13. One or more baffle plates 298 are positioned about the hydrogen pump cylinders 310/312. The baffle plates 298 extend to the insulated vacuum jacket 223 and interrupt convection currents within the insulated vacuum jacket 223. In some embodiments, the baffle plates are curved or angled with respect to the vertical axis 150. In some embodiments, the baffle plates 298 are non-structural members. In other embodiments, the baffle plates 298 further provide stiffening.

The upper ends 314/316 of the thermal decoupling rods 210 and 212 non-fixedly mate with receptacles 318/320 of hydrogen pistons 322/324, respectively. To reduce thermal conductivity between the hydrogen pistons 322/324 and components outside of the cold end portion 152, the thermal decoupling rods 210 and 212 are formed from austenitic steel. In addition to low thermal conductivity, the thermal decoupling rods 210 and 212 thus exhibit low corrosion characteristics.

The hydrogen pistons 322/324 slidingly engage blow-by seals 326/328 which are positioned within couplers 327/329 which sealingly couple the thermal decoupling cylinders 300/302 are fixedly connected to hydrogen pump cylinders 310 and 312. In some embodiments baffle plates like the baffle plates 296/298 are positioned around the couplers 327/329. Each hydrogen piston 322/324 is identically formed and, as described with respect to the hydrogen piston 322 shown in FIG. 14, include at their upper ends at least one guide ring 330 and multiple seal rings 334.

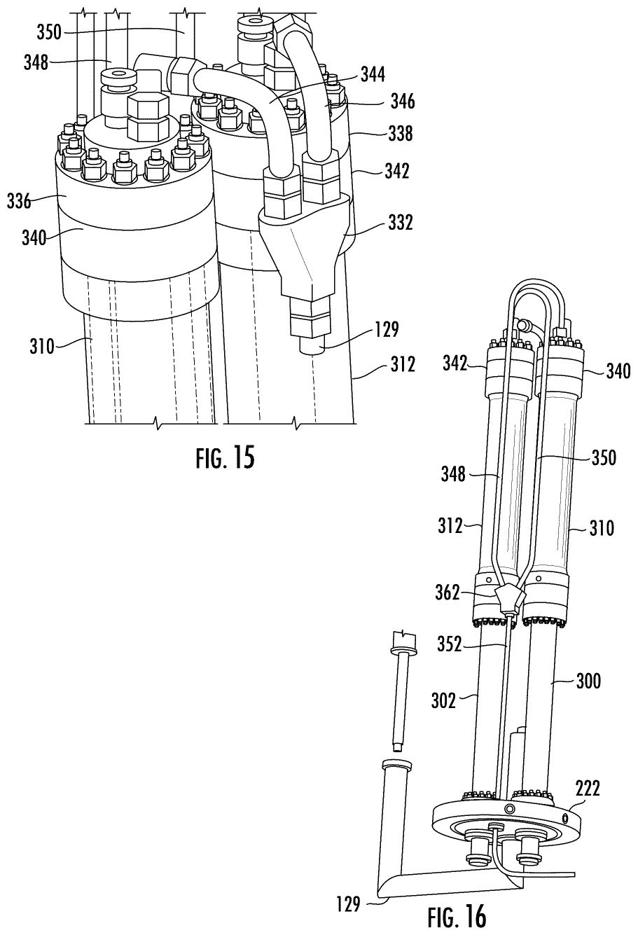

The hydrogen pump cylinders 310 and 312 are connected to respective cylinder heads 340/342 as also shown in FIG. 15. The cylinder heads 340/342 function as a roof for the respective hydrogen pump cylinders 310 and 312. A variable volume working chamber 335 is defined by the upper portion of the hydrogen pump cylinders 310/312, the roof portion provided by the cylinder heads 340/342, and the upper end of the hydrogen pistons 322/324.

Each of the hydrogen pump cylinders 310/312 are supplied by the first stage supply header 129 through respective supply feed lines 344/346 which extend to pump caps 336/338. The pump caps 336/338 include respective low-pressure passages 354 (see FIG. 14) which communicate with valve chambers 356 within the cylinder heads 340/342. A seal ring 358 provides a seal between the pump caps 336/338 and the cylinder heads 340/342 between the low-pressure passages 354 and the valve chambers 356.

The cylinder heads 340/342 include a stepped combination valve/coupling chamber 392 which is aligned with an insert passage 394 of the pump caps 336/338. As shown in FIG. 14, the stepped combination valve/coupling chamber 392 and insert passage 394 extend parallel to the vertical axis 150. This minimizes the lineal distance of, for example, the stepped combination valve/coupling chamber 392 within the cylinder heads 340/342 to reduce transmission of energy from expelled hydrogen moving through the cylinder heads 340/342, while also reducing the footprint of the cold end portion 152. The valve chambers 356 are also parallel to the vertical axis 150 within the cylinder heads 340/342. Within the pump caps 336/338, the low-pressure passages 354 are somewhat angled with respect to the vertical axis 150 to reduce warming of the area around the low-pressure passages 354 by pressurized gas moving through the cylinder heads 340/342.

An insert 396 passes through the insert passage 394 and includes a threaded bottom portion which threadedly engages a threaded bottom portion of the valve/coupling chamber 392. A seal 398 seals the insert 394 with the cylinder heads 340/342 and a vent (not shown) beneath the threads of the insert 394 vents any hydrogen leakage into the valve/coupling chamber 392.

The stepped combination valve/coupling chamber 392 and insert 396 connect the hydrogen pump cylinders 310/312 to second stage discharge lines 348/350 which supply, through a junction 366, second stage discharge header 352 (see FIG. 16) which in turn supplies the ready storage tank 110 (see FIG. 1). The second stage discharge lines 348/350 are physically crossed before connecting to the second stage discharge header 352 (FIG. 16). This reduces the footprint of the cold end portion thereby reducing the required diameter of the insulated vacuum jacket 223. The reduced volume required for two hydrogen pump cylinders 310/312, and thus two thermal decoupling cylinders, provides a more efficient use of the cryogenic insulation material of the insulated vacuum jacket 223.

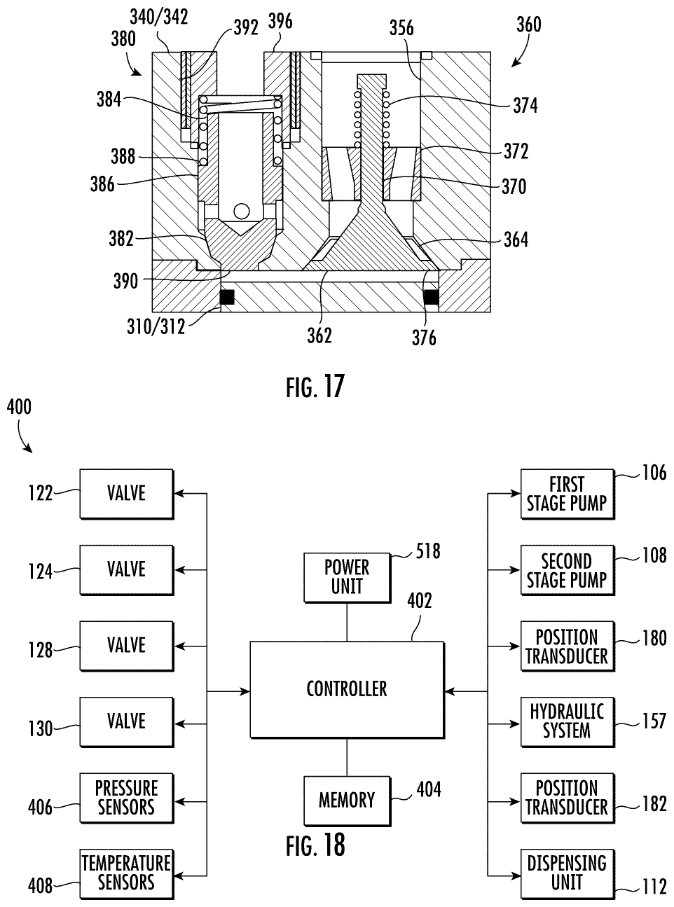

Within the cylinder heads 340/342, check valves are provided to isolate the hydrogen pump cylinders 310/312. While only the cylinder head 340 is described in detail with respect to FIG. 17, the cylinder head 342 includes the identical components. Accordingly, reference to the components within the cylinder head 342 will be made using the same reference numbers as those used in describing the cylinder head 340.

Referring to FIG. 17, the low-pressure passage 354 feeds the hydrogen pump cylinder 310 through an inlet check valve 360 positioned within the valve chamber 356. The inlet check valve 360 includes a poppet seat 362 with a seal 364. A stem 370 extends from the poppet seat 362 through a flow guide 372 and is surrounded by a spring 374 which biases the poppet seat 362 toward a closed position against conical hydrogen pump cylinder inlet 376 shown in FIG. 17.

The second stage discharge line 348 is fed through an outlet check valve 380 positioned within the stepped combination valve/coupling chamber 392 and includes a seat 382. A stem 384 extends from a flow guide 386 located above the seat 382 and is surrounded by a spring 388 which biases the seat 382 toward the hydrogen pump cylinder outlet 390 and the closed position shown in FIG. 17. The stepped combination valve/coupling chamber 392 is substantially parallel to the valve chamber 356. This allows for a more compact arrangement of the inlet/outlet components of the cylinder heads 340/342, with little or no clearance volume when the hydrogen pistons 322/324 are fully extended since both the inlet and the outlet are positioned in the roof of the hydrogen pump cylinders 310/312 rather than the cylindrical portions of the hydrogen pump cylinders 310/312.

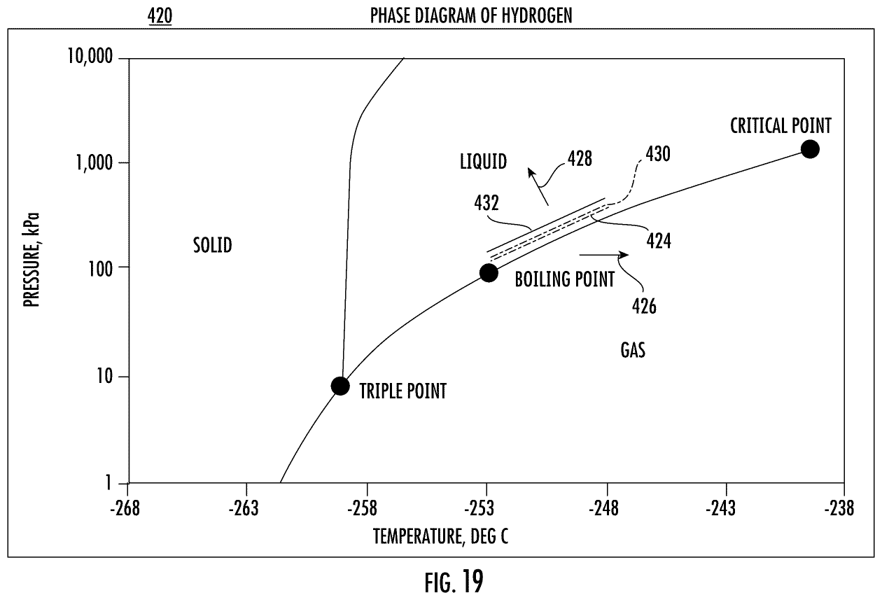

The hydrogen fueling station 100 is controlled by a control system 400 shown in FIG. 18. The control system 400 includes a controller 402 and a memory 404. The controller 402 is operably connected to the memory 404 which in some embodiments is separately provided and in other embodiments is part of the controller 402. The controller 402 is operably connected to the other components of the hydrogen fueling station 100, including various pressure sensors 406 and temperature sensors 408 positioned throughout the hydrogen fueling station 100.

Stored within the memory 404 are program instructions which, when executed by the controller 402, cause the hydrogen fueling station 100 to perform various operations such as refilling the bulk storage tank 104. The controller 402 further executes the program instructions to fill the ready storage tank 110.

Refilling of the ready storage tank 110 may be controlled in response to various inputs such as a user input, a low pressure reading from a pressure sensor 406 of the ready storage tank 110, and/or from a signal from the dispensing unit 112 indicating that the nozzle 114 has been connected to the receiver 116 and is being used, or is about to be used, to fill the tank 118. For example, the controller 402 in some embodiments receives a signal from the dispensing unit 112 indicating that an amount of fuel required to fill the hydrogen tank 118 will cause the ready storage tank 110 to drop below a threshold pressure so that the controller 402 can begin filling the ready storage tank 110 before the low-pressure threshold is reached.

Operation of the hydrogen fueling station by execution of the program instructions within the memory 404 to provide hydrogen to the ready storage tank 110 in response to such a signal is described with reference to the following exemplary method wherein further details of the hydrogen fueling station 100 are provided.

Initially, the controller 402 executes the program instruction to ensure proper preliminary conditions are met. In addition to ensuring adherence to various safety protocols, the controller 402 obtains pressure and temperature data from throughout the hydrogen fueling station 100. The controller 402 further establishes a valve line-up necessary for charging the ready storage tank 110 including controlling the isolation valves 124 and 128 to open positions. When filling is from only the bulk storage tank 104, the controller 402 further ensures that the isolation valve 122 is in the closed position. Depending upon whether the dispensing unit is being used, the isolation valve 130 may be open or shut.

The controller then controls the one or more first stage pump 106 to provide a desired flow rate of hydrogen at a desired pressure. The desired flow rate and pressure is a function of the temperature of various components within the hydrogen fueling station 100 and is determined by the controller using, for example, look-up tables stored within the memory 404. In particular, when the controller initiates a refilling operation, various components within hydrogen fueling station 100 are warmer than the hydrogen stored within the bulk storage tank 104. If the hydrogen is warmed sufficiently relative to the pressure at a particular location within the hydrogen fueling station 100, the hydrogen will change to a vapor state which inhibits operation of, for example, the second stage pump 108.

Additionally, during the filling operation the temperatures within the system change. For example, moving components will generate heat while the hydrogen will be cooling/heating the pipes/chambers depending upon the relative temperature of the components and the hydrogen at that point in the system. Thus, the controller 402 in one embodiment monitors temperatures and pressures throughout the hydrogen fueling station 100 during the entire refilling operation.

The controller 402 in one embodiment controls the first stage pump 106 to supercool the hydrogen at the outlet of the first stage pump 106 using a phase diagram stored in the memory 404. One such phase diagram is the phase diagram 420 shown in FIG. 19. As shown in FIG. 19. the hydrogen within the bulk storage tank 104 is stored at a pressure of about 0 to 2.5 barg and a temperature of 20 to 25K as indicated by the curve 424. Simply pumping the hydrogen without increasing pressure would move the hydrogen in the direction of the arrow 426 toward a gaseous state. Increasing the pressure of the hydrogen “super cools” the hydrogen by moving the curve 424 in the direction of the arrow 428. While horizontally configured hydrogen fueling stations supercool to about the line 430, the controller 402 further controls the first stage pump 106 to supercool the hydrogen at the outlet of the first stage pump 106 to the curve 432 so as to allow for configuration of the hydrogen fueling station 100 as discussed more fully below. This results in potentially a 10 bar increase in pressure. In one embodiment, the hydrogen fluid is discharged from the first stage pump 106 at a pressure of 4-20 bar at a temperature of 20-22 degrees Kelvin.

The outlet of the first stage pump 106 is provided to the first stage supply header 129 and is split between the supply feed lines 344 and 346 by a junction 332. Each of the supply feed lines 344 and 346 has the same size (and thus flow rate) as the first stage supply header 129 (see FIG. 15) since only one of the hydrogen pump cylinders 310/312 is filled at a given time. So as to account for expansion during warming of the first stage supply header 129 and contraction of the first stage supply header 129 as the hydrogen gas cools the first stage supply header 129, at least portions of the first stage supply header 129 are formed from flex piping.

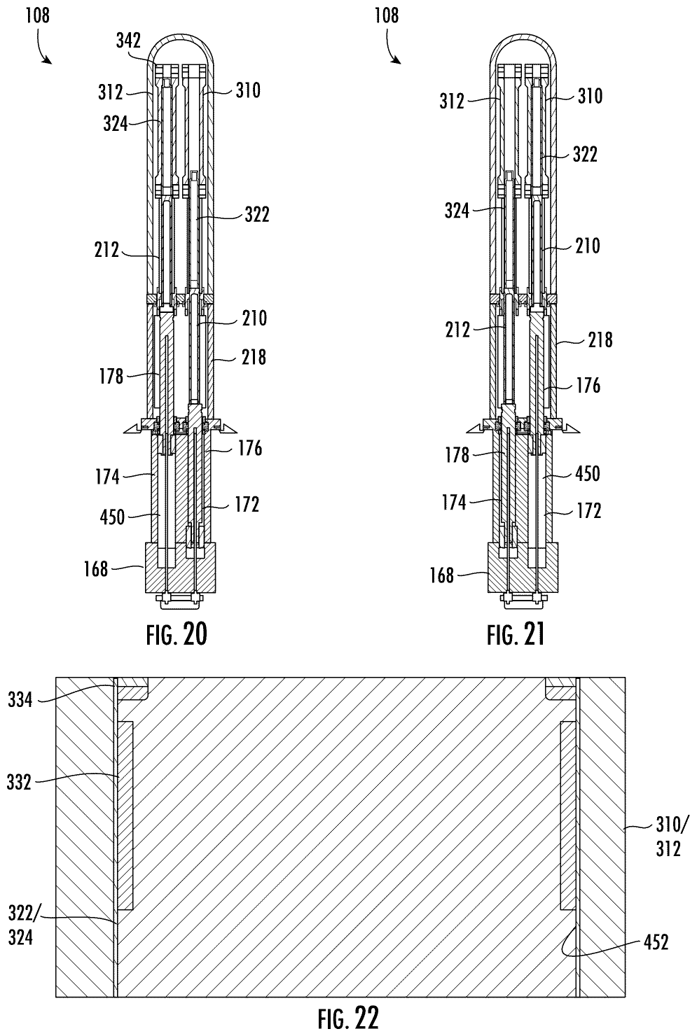

As pressure within the feedlines 344 and 346 begins to increase, the controller 402 selects one of the hydrogen pistons 322 and 324 which is fully extended and controls the hydraulic system 157 to retract the associated hydraulic piston as discussed in further detail below. In FIG. 20, only one of the hydrogen pistons 322 and 324 is fully extended, namely, hydrogen piston 324. In some embodiments, however, both hydrogen pistons 322 and 324 are in a fully extended position when the system is in a stand-by condition as discussed more fully below.

In any event, retraction is accomplished in the condition of FIG. 20 by controlling the hydraulic system 157 such that the hydraulic motor pump assemblies 160/162 take a suction on the hydraulic cylinder 174 and provide discharge to the hydraulic cylinder 172.

The hydrogen pistons 322 and 324 and the hydrogen pump cylinders 310/312 are designed such that the roof provided by the cylinder heads 340/342 function as mechanical stops for the hydrogen pistons 322 and 324. In some embodiments, a further component is provided which functions specifically as a mechanical stop. Consequently, there is very little clearance volume in the respective hydrogen pump cylinders when the hydrogen pistons 322 and 324 are fully extended. Thus, the hydrogen piston 312 is shown in FIG. 20 positioned against the cylinder head 342. The upper surfaces of the hydrogen pistons 322 and 324 are grooved in some embodiments to prevent sticking of the hydrogen pistons 322 and 324 to the mechanical stops.

As the hydraulic fluid 450 is removed from the hydraulic cylinder 174 the hydraulic piston 178 is pulled downwardly by the receding hydraulic fluid 450. The thermal decoupling rod 212 which is fixedly coupled to the hydraulic piston 178 is likewise pulled downwardly. As noted above, the thermal decoupling rod 212 is not mechanically coupled to the hydrogen piston 324. Consequently, the hydrogen piston 324 is not forcefully withdrawn by the return stroke of the hydraulic piston 178 which may result in formation of a vacuum. Rather, the pressure within the hydrogen pump cylinder 312 simply drops to a pressure at which the pressure in the supply feedline 346 against the area of the poppet seat 362 exceeds the pressure within the hydrogen pump cylinder 312 plus the pressure required to compress the spring 374 (FIG. 17).

Compression of the spring 374 allows hydrogen within the supply feedline 346 to flow past the poppet seat 362 into the hydrogen pump cylinder 312. The poppet seat 362 is formed from stainless steel, as is discussed more fully below, while the seal 364 is made from polymer. The polymer seal is needed because stainless steel does not function well as a seal.

In one embodiment, the supply feedline has a diameter of 21 mm while the diameter of the hydrogen pump cylinder has a diameter of 62 mm. Consequently, even with the mechanical decoupling of the thermal decoupling rod 212 and the hydrogen piston 324, as the fluid hydrogen moves past the poppet seat 362 into the significantly larger diameter of the hydrogen pump cylinder 310, the pressure of the fluid hydrogen drops significantly. The increased supercooling provided by the first stage pump 106, however, prevents or significantly prevents flashing to vapor. Consequently, smaller valves, which generate larger pressure drops, can be used without excessive vapor forming. The ability to use smaller components simplifies design considerations including component layout.

The increased supercooling is effective in guarding against vapor generation even when performing a warm start. The increased supercooling thus enables a significantly longer stroke length of the hydraulic pistons and thus the hydrogen pistons even as the incoming hydrogen gas is gaining energy by warming from the components in the cold end portion 152. For example, a typical hydrogen piston has a maximum stroke length of about 170 mm in a hydraulic configuration or 28-100 mm in crankshaft configurations. The hydrogen pistons 176/178 in contrast have stroke length of more than 300 mm. In one embodiment, the stroke length is 600 mm.

The extended stroke length provides significant benefits including a higher startup ratio. Consequently, the hydrogen fueling station 100 is capable of immediately pressurizing hydrogen even when starting from a warm condition. In particular, when the system is warm some amount of vaporization within the hydrogen pump cylinders is expected since the components associated with the secondary pump, including the associated piping, have not been cooled by movement of hydrogen fluid therethrough.

With traditional short stroke hydrogen pumps, the vapor bubble formed during startup can be so large compared to piston stroke length that even at a full stroke the short stroke hydrogen pumps cannot eject fluid hydrogen due to the relatively large clearance volume. Consequently, no, or very little, fluid hydrogen is pulled into the pump on the return stroke. Since little or no fluid hydrogen is flowing through the system, little if any cooling is effected. Consequently, the system remains warm. So as to prevent this scenario, typical hydrogen filling stations are oriented horizontally. In particular, since the hydrogen gas will migrate upwardly, a horizontal cylinder orientation allows any fluid in the horizontal cylinders to be pumped even with a relatively large clearance volume between the piston and the compression chamber end cap.

With the increased stroke length of the present system, however, even with significant vapor formation in the hydrogen pump cylinders, some amount of fluid hydrogen is ejected. The ejection of fluid hydrogen is enabled not only by the increased stroke length, but also by the significantly smaller clearance volume in the hydrogen pump cylinders at full extension of the pistons. The controller 402 is able to finely control the extension of the pistons to just touch the end of the hydrogen pump cylinders in part because of the very precise position detection of the hydraulic pistons 176/178 possible using the high precision position transducers 180/182.

Consequently, the hydrogen fueling station 100 is capable of ensuring flow of fluid hydrogen through the second stage pump and its associated components even from a warm start. This flow of liquid hydrogen through the components rapidly cools the components in the cold end portion 152 allowing for a rapid realization of high efficiency operation. Accordingly, the more efficient cooling resulting from the incorporation of long strokes coupled with smaller clearance volume reduces the energy transfer per unit mass on the inlet fluid.

Once the hydraulic cylinder 174 is completely withdrawn as shown in FIG. 21, the controller 402 controls the hydraulic system such that the hydraulic motor pump assemblies 160/162 take a suction on the hydraulic cylinder 172 and provide discharge to the hydraulic cylinder 174. Continued operation of the hydraulic motor pump assemblies 160/162 forces the hydraulic piston 174 upwardly thereby forcing the thermal decoupling rod 212 and the hydrogen piston 324 upwardly. The upward movement of the hydrogen piston 324 causes compression of the hydrogen fluid just introduced in the hydrogen pump cylinder 312.

As the hydrogen fluid within the hydrogen pump cylinder 312 is compressed, the pressure of the hydrogen fluid increases from about 4-10 bar to 900-950 bar. This compression of the hydrogen fluid causes an increase in temperature of the hydrogen fluid to about 45-70 degrees Kelvin. Even with this increase in the temperature, the increased pressure maintains the hydrogen fluid in a supercritical state.

As the pressure in the hydrogen pump cylinder 312 increases to above the pressure in the second stage discharge line 350 and the force added by the spring 388 (FIG. 17), the seat 382 of the outlet check valve 380 is lifted to an open position and the pressurized hydrogen fluid within the hydrogen pump cylinder 312 moves into the second stage discharge line 352 and toward the ready storage tank 110. This continues until the hydrogen piston 324 is positioned against the mechanical stop which in this embodiment is the top of the hydrogen pump cylinder 312, or to another controlled height.

As the hydrogen fluid is moving through the outlet check valve 380, the inlet check valve is exposed to the 900-950 bar pressure within the hydrogen pump cylinder 312. Moreover, as is evident from FIG. 17, the area of the poppet seat 362 which is exposed to this increased pressure is larger than the area of the poppet seat 362 which is exposed to the lower pressure from the supply feed line 346. Consequently, the poppet seat is required to be made from strong material. In this embodiment stainless steel is used. Since stainless steel does not provide the desired sealing characteristics as discussed above, the polymer seal 364 is provided.

The seat 382, however, is made from a plastic material. The seat 382 does not require the same strength as the poppet seat 362. While a similarly large differential pressure is experienced across the seat 382, FIG. 17 shows that the high pressure in the second stage discharge line 350 is applied to a smaller area since the second stage discharge lines have a diameter of about 8 mm.

As noted above, the temperature of the high-pressure hydrogen fluid is about 45-70 degrees Kelvin which is much higher than the temperature of the incoming hydrogen fluid. Some of this heat is added to the incoming hydrogen fluid because of the closeness of the inlets and the outlets within the roof of the hydrogen pump cylinders 310/312. Because of the extra super cooling provided by the first stage pump 106, however, the added heat does not result in vaporization issues within the hydrogen pump cylinders 310/312. The extra super cooling provided by the first stage pump 106 thus allows for the close positioning of the hydrogen pump cylinder inlet 376 and the hydrogen pump cylinder outlet 390 in the roof of the hydrogen pump cylinders 310/312 providing a simplified design compared to prior systems, as well as reducing the required diameter of the system.

With reference to FIG. 22, as the hydrogen pistons 322/324 pressurize the fluid hydrogen during a power stroke, the seal rings 334 inhibit leakage around the hydrogen pistons 322/324. Some hydrogen fluid, however, moves past the seal rings 334 and the guide rings 330 into the small area 452 between the hydrogen pistons 322/324 and the inner wall of the hydrogen pump cylinders 310/312. The pressure within this small area 452 is much less than the pressure within the hydrogen pistons 322/324 during the power stroke. Accordingly, the leakage typically vaporizes. The continuous filling of the small area 452 with leakage from the pressurized hydrogen fluid ensures that no mixing of further combustible gasses can occur within the hydrogen pistons 322/324.

As the hydrogen pistons 322/324 retract, the seals 334 cause the pressure of the hydrogen fluid/vapor within the small area 452 to increase. The blow by seals 326/328 (FIG. 13) are designed to allow venting of the hydrogen vapor therethrough at above about 10 bar. This provides a continuous source of hydrogen gas into the thermal decoupling cylinders 300/302. As shown in FIG. 12, the cold end portion base plate 322 includes the vent line 304 which provides a leakage path for the hydrogen vapor. Pressure within the vent line 304, and hence the thermal decoupling cylinders 300/302, is maintained at less than 5 bar, preferably less than 4 bar, and more preferably at 3 bar, by a pressure relief valve 305 operably connected to the vent line 304. The pressure relief valve 305 releases escaping hydrogen gas to atmosphere or to a reclamation system.

While the hydrogen pistons 322/324 are completely bathed with the hydrogen vapor described above, FIGS. 20 and 21 show that the thermal decoupling rods 210/212 are periodically moved into the intermediate portion housing 218. The intermediate portion housing 218 is maintained at atmospheric pressure. While care is taken to fully insulate and seal the intermediate portion housing 218 such that chances of explosion are reduced, the atmosphere within the intermediate housing is likely to contain some amount of moisture and contaminants. Consequently, since the thermal decoupling rods 210/212 are the boundary between the cold hydrogen pistons 322/324 and the warm hydraulic pistons 176/178 and become cold, some ice may form on the thermal decoupling rods 210/212 within the intermediate portion housing 218. The seals 230, the scraper 266, and the ice scraper 272 shown in FIGS. 8-11 prevent the ice and other contaminants from moving into the thermal decoupling cylinders 300/302 while preventing hydrogen gas from moving out of the thermal decoupling cylinders 300/302 into the intermediate portion housing 218

As shown in FIGS. 8 and 9, the groove 242 of the seal component 238 is U-shaped with its open side oriented toward the thermal decoupling cylinders 300/302. Since the pressure within the thermal decoupling cylinders 300/302 is maintained at about 3 bar, the pressure within the thermal decoupling cylinders 300/302 is greater than the atmospheric pressure within the intermediate portion housing 218. This pressure differential thus adds to the force generated by the compressed inner spring component 248 further forcing the sealing lip 244 against the thermal decoupling rods 210/212 to ensure a tight seal inhibiting passage of helium gas from the thermal decoupling cylinders 300/302 into the intermediate portion housing 218.

Current state of the art systems incorporate special measures to protect seals around rods which extend from a cold portion of a pump. These special measures include the addition of heat to preclude formation of ice on the rods. While effective in preventing ice buildup, the added heat is transferred into the cold portions of the pump thereby decreasing efficiency. In other approaches, a special environment is maintained to preclude the possibility of ice formation. These approaches can be expensive to build and to maintain.

In the embodiment of FIG. 9, the seals 230 are protected from damage by the scraper 266. The scraper 266 is made from plastic and is configured to remove any contaminants on the thermal decoupling rods 210/212 thereby protecting the seals 230 from damage and preventing contaminates from being introduced into the thermal decoupling cylinders 300/302. Plastic scrapers, however, tend to be easily damaged in the presence of ice which may form on thermal decoupling rods 210/212. Accordingly, the ice scrapers 272 are provided to extend the life of the scrapers 266.

So as to provide increased lifetime, the ice scrapers 272 shown in FIGS. 9-11 are formed from brass. Brass is soft enough that the austenitic stainless steel thermal decoupling rods 210/212 are not scored by the ice scrapers 272. Moreover, the presence of copper within the ice scrapers 272 results in increased ductility in the cold environment created within the intermediate housing portion 218.

The type of ice which typically forms on the thermal decoupling rods 210/212 is a thin ice film rather than a bulk ice. The scalloping of the lower edge 292 which does not extend completely through the inner surface 290 provides increased effectiveness in removing thin ice films. In particular, compared to thick ice, thin ice tends to form a bond with the underlying surface which is closer to the strength of the bond with other portions of the ice. Consequently, simply applying force to a portion of the ice will not result in complete removal from an underlying surface. Therefore, the inner surface 290 of the ice scrapers 272 provide a continuous contact surface around the circumference of the thermal decoupling rods 201/212 for complete de-icing while the scalloping helps to focus force to initiate interruption of the ice-ice bonds.

Because the inner surface 290 of the ice scrapers 272 provide a continuous contact surface around the circumference of the thermal decoupling rods 210/212, any contaminants scraped by the plastic scraper 266 cannot be removed through the thermal decoupling rods 210/212 and ice scraper 272 interface. Accordingly, the holes 294 are provided to allow the contaminates to be removed from the cavity 274.

As a result of the vertical orientation of the second stage pump 108, any ice or contaminants scraped by the scraper 266 or the ice scraper 272 fall to the hydraulic top plate 196 of the hydraulic cylinder housing 158 (see FIG. 4) which is relatively warm. Accordingly, any such ice melts and evaporates. Thus, there is no issue with ice/fluid accumulation as is experienced with other pump configurations, and the thermal decoupling cylinders 300/302 are better protected from contaminants.

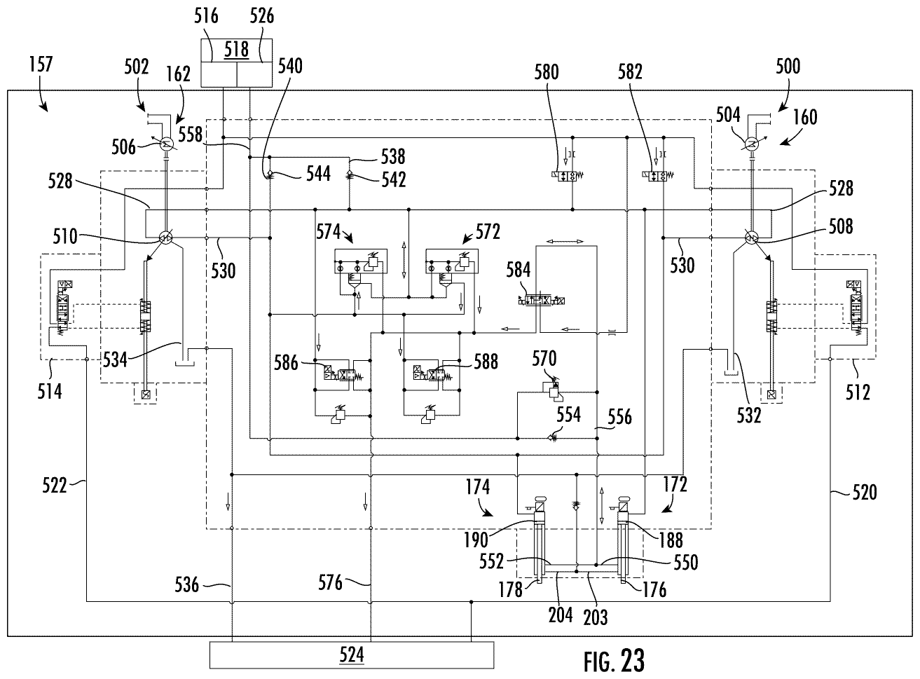

One embodiment of the hydraulic system 157 of FIG. 3 is shown in FIG. 23. As shown in FIG. 23, hydraulic volume sources in this embodiment are provided by the hydraulic motor assemblies 160/162. In some embodiments, only a single hydraulic volume source is incorporated.

Water cooling lines 500/502 are provided to cool the motors 504/506 of the hydraulic motor assemblies 160/162. The motors 504/506, which in one embodiment are servo motors, are operably connected to swashplate assemblies 508/510 which are controlled by control valve assemblies 512/514. The control valve assemblies 512/514 port control hydraulic fluid provided by a hydraulic volume source which in this embodiment is pilot pump 516 of a power unit 518 to control positioning of the swashplate assemblies 508/510. The control hydraulic fluid leaves the control valve assemblies 512/514 through drain lines 520/522 and is directed to a hydraulic fluid conditioning unit 524. The hydraulic fluid conditioning unit 524 filters and cools/heats the hydraulic fluid and supplies the conditioned fluid, directly and/or through a reservoir, to the pilot pump 516 and another hydraulic volume source in the form of charge pump 526.

The swashplate assemblies 508/510 are each configured to be controllably positioned at neutral positions whereat the hydraulic motor assemblies 160/162 do not pump any hydraulic fluid even with rotation of the motors 504/506, a second position (or positions) whereat the swashplate assemblies 508/510 take a suction on connecting line 528 while discharging to connecting line 530, and a third position (or positions) whereat the swashplate assemblies 508/510 take a suction on connecting line 530 while discharging to connecting line 528.

The connecting line 528 is in fluid communication with the hydraulic cylinder 172 while the connecting line 530 is in fluid communication with the hydraulic cylinder 174. Consequently, when controlled to the second position (or one of the second positions), the hydraulic motor assemblies 160/162 take a suction on the hydraulic cylinder 174 through connecting line 530 while discharging hydraulic fluid to the hydraulic cylinder 172 through connecting line 528. When controlled to the third position (or one of the third positions), the hydraulic motor assemblies 160/162 take a suction on the hydraulic cylinder 172 through connecting line 528 while discharging hydraulic fluid to the hydraulic cylinder 174 through connecting line 530. The hydraulic system 157 is thus a mechanically decoupled close looped system.

Within the closed looped hydraulic system 157, hydraulic fluid leakage occurs both within the swashplate assemblies 508/510 and out of the hydraulic cylinders 172/174. Accordingly, low-pressure lines in the form of drain lines 532/534 are provided for the swashplate assemblies 508/510 while the drain lines 203/204 (see also FIG. 4) are provided for the hydraulic cylinders 172/174. The hydraulic drain lines 203/204 are in direct fluid communication with each other. Each of the drain lines 532/534/203/204 are connected to a further low-pressure line in the form of leakage line 536 which is directed to the hydraulic fluid conditioning unit 524.

The charge pump 526 is provided to account for the hydraulic fluid which leaks past the swashplate assemblies 508/510 and out of the hydraulic cylinders 172/174. The charge pump 526 supplies makeup hydraulic fluid directly to the connecting lines 528/530 through makeup lines 538/540, each of which is provided with a respective check valve 542/544.

The charge pump 526 further provides hydraulic coupling for the hydraulic cylinders 172/174. In particular, the charge pump 526 supplies stiffening lines 550 and 552 which are in fluid communication with the hydraulic cylinders 172/174 at locations above the piston seals 188/190 (note the hydraulic cylinders 172/174 are depicted upside down in FIG. 23 for ease of depiction) in the low-pressure portions 189/191. The stiffening lines 550 and 552 are pressurized by the charge pump 526 through check valve 554 and stiffening header 556 by way of a charge pump header 558. Accordingly, when the hydraulic motor assemblies 160/162 take a suction on, e.g., the hydraulic cylinder 172, the upper side of the piston seal 188 is pressurized from the stiffening header 556 to assist in moving the hydraulic piston 176 downwardly. Since there are no valves between the stiffening header 556 and the low-pressure portions 189/191 as shown in FIG. 23, the stiffening header 556 is in direct fluid communication with the low-pressure portions 189/191.

Moreover, as the piston seal 190 begins to move upwardly, hydraulic fluid above the piston seal 190 is pressurized. To ensure that the stiffening header 556 is not over pressurized, a relief valve 570 is provided to allow hydraulic fluid to move back into the charge pump header 558. Over pressurization of the charge pump header 558 is in turn provided through the check valves 542/544 which pass hydraulic fluid to the lower pressure one of the connecting lines 528/530.

In particular, pressure relieved through the relief valve 570 is applied to the check valves 542/544. The check valve associated with the connecting line 528/530 which is supplying the hydraulic motor assemblies 160/162 will allow any over pressure to be released into the associated connecting line. Over pressurization of the connecting lines 528/530, in turn, is provided by relief assemblies 572/574, which in this embodiment are controllable valves, which discharge to drain line 576 which is directed to the hydraulic fluid conditioning unit 524.

The hydraulic system 157 can further be controlled by the controller 402 to individually extend the hydraulic pistons 176/178 to any desired location when the motors 504/506 are not being used to pump hydrogen. Thus, in a standby condition the controller 402 can control the hydraulic system to position both hydrogen pistons 322/324 against their respective stops, e.g., the roof of the respective hydrogen pump cylinders 310/312. This is accomplished using the pilot pump 516.

In particular, the pilot pump 516 discharge can be selectively applied to the connecting line 528 through a controllable valve in the form of standby control valve 580, and/or to the connecting line 530 through a controllable valve in the form of standby control valve 582 under control of the controller 402. Thus, control hydraulic fluid can be applied to the high-pressure portions 193/195 of the hydraulic cylinders 172/174 using the same lines used by the motors 504/506 so as to selectively extend the hydraulic pistons 176/178, although at a significantly reduced pressure.

When extending one of the hydraulic pistons 176/178 in the standby mode, the pressure achieved by the pilot pump 516 is not sufficient to exceed the threshold of the relief valve 570. Accordingly, hydraulic fluid within the low-pressure portions 189/191 is released by controlling a controllable valve in the form of the standby relief valve 584 to port hydraulic fluid from the stiffening header 556 to drain line 576. Thus, both hydrogen pistons 322/324 can be positioned against the cylinder heads 340/342 in a standby mode.

The controller 402 uses the charge pump 526 to selectively retract the hydrogen pistons 322/324 to a desired position when the system is in a standby mode. This can be useful in initially positioning the system in preparation for a hydrogen pumping operation. In particular, the discharge of the charge pump 526 is applied to the stiffening header 556 as discussed above which applies hydraulic fluid from the charge pump 526 to the low-pressure portions 189/191 of the hydraulic cylinders 172/174. Since the high-pressure portions 193/195 of the hydraulic cylinders 172/174 are in fluid communication with the connecting lines 528/530, the high-pressure portions 193/195 are ported to the leakage line 536 by controllable valves in the form of standby port control valves 586/588, respectively, to allow selective retraction of the hydraulic pistons 176/178. The standby port control valves 586/588 can also be controlled during operation of the system to provide additional flushing as needed.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. By way of example, while four different hydraulic volume sources are described with reference to FIG. 23, in some embodiments a single source is used to provide all of the hydraulic volume. Thus, one or more of the volume sources is replaced with a pressure reducing line fed from a main hydraulic pump, a pressurized reservoir, and various combinations of components. One or more of the hydraulic volume sources in some embodiments includes one or more of a vane pump, a piston pump, a screw pump, an electric pump, a fixed displacement pump, and a gear pump. Moreover, while the system described above is a vertically oriented system, many of the improvements can be incorporated into systems with other orientations such as horizontal orientations.

We claim:

1. A hydrogen fueling station including a cryogenic pump, the cryogenic pump comprising:
a cold end portion base plate;
a cylindrical insulated vacuum jacket attached to the cold end portion base plate and extending away from the cold end portion base plate;
a first hydrogen pump cylinder positioned within the cylindrical insulated vacuum jacket;
a second hydrogen pump cylinder positioned within the cylindrical insulated vacuum jacket, the second hydrogen pump cylinder oriented parallel to the first hydrogen cylinder;
a first hydraulic cylinder positioned outside of the cylindrical insulated vacuum jacket and aligned with the first hydrogen pump cylinder, the cold end portion base plate positioned between the first hydraulic cylinder and the first hydrogen pump cylinder; and
a second hydraulic cylinder located outside of the cylindrical insulated vacuum jacket and adjacent to, and oriented parallel to, the first hydraulic cylinder and aligned with the second hydrogen pump cylinder, the cold end portion base plate positioned between the second hydraulic cylinder and the second hydrogen pump cylinder.

2. The hydrogen fueling station of claim 1, wherein:
a portion of a supply header extends through the cold end portion base plate;
the portion of the supply header is in fluid communication with the first hydrogen pump cylinder and the second hydrogen pump cylinder;
a portion of a discharge header extends through the cold end portion base plate; and
the portion of the discharge header is in fluid communication with the first hydrogen pump cylinder and the second hydrogen pump cylinder.

3. The hydrogen fueling station of claim 2, further comprising:
a first junction located within the cylindrical insulated vacuum jacket; and
a second junction located within the cylindrical insulated vacuum jacket wherein
the portion of the supply header is in fluid communication with the first hydrogen pump cylinder through the first junction and a first supply feed line,
the portion of the supply header is in fluid communication with the second hydrogen pump cylinder through the first junction and a second supply feed line,
the portion of the discharge header is in fluid communication with the first hydrogen pump cylinder through the second junction and a first discharge line, and
the portion of the discharge header is in fluid communication with the second hydrogen pump cylinder through the second junction and a second discharge line.

4. The hydrogen fueling station of claim 3, wherein the first discharge line and the second discharge line are crossed at a crossing location within the cylindrical insulated vacuum jacket whereat the first hydrogen pump cylinder and the second hydrogen pump cylinder are located between the crossing location and the cold end portion base plate.

5. The hydrogen fueling station of claim 4, wherein:
the first hydrogen pump cylinder has a first cylinder head;
the second hydrogen pump cylinder has a second cylinder head;
the first supply feed line is in fluid communication with the first hydrogen pump cylinder through the first cylinder head;
the first discharge line is in fluid communication with the first hydrogen pump cylinder through the first cylinder head;
the second supply feed line is in fluid communication with the second hydrogen pump cylinder through the second cylinder head; and
the second discharge line is in fluid communication with the second hydrogen pump cylinder through the second cylinder head.

6. The hydrogen fueling station of claim 5, wherein:
a first inlet check valve is located within the first cylinder head;
the first inlet check valve includes a poppet seat made from a metal material and a seal made from a polymer; and
the first supply feed line is in fluid communication with the first hydrogen pump cylinder through the first inlet check valve.

7. The hydrogen fueling station of claim 6, wherein at least a portion of the portion of the supply header within the cylindrical insulated vacuum jacket is formed from flex piping.

8. The hydrogen fueling station of claim 7, further comprising:
at least one first stage pump configured to provide hydrogen to the supply header.

9. A cryogenic pump comprising:
a cold end portion base plate;
a cylindrical insulated vacuum jacket attached to the cold end portion base plate and extending away from the cold end portion base plate;
a first hydrogen pump cylinder positioned within the cylindrical insulated vacuum jacket;
a second hydrogen pump cylinder positioned within the cylindrical insulated vacuum jacket, the second hydrogen pump cylinder oriented parallel to the first hydrogen cylinder piston;
a first hydraulic cylinder positioned outside of the cylindrical insulated vacuum jacket and aligned with the first hydrogen pump cylinder, the cold end portion base plate positioned between the first hydraulic cylinder and the first hydrogen pump cylinder; and
a second hydraulic cylinder located outside of the cylindrical insulated vacuum jacket and adjacent to, and oriented parallel to, the first hydraulic cylinder and aligned with the second hydrogen pump cylinder, the cold end portion base plate positioned between the second hydraulic cylinder and the second hydrogen pump cylinder.

10. The cryogenic pump of claim 9, further comprising:
a supply header portion extending through the cold end portion base plate and in fluid communication with the first hydrogen pump cylinder and the second hydrogen pump cylinder; and
a discharge header portion extending through the cold end portion base plate and in fluid communication with the first hydrogen pump cylinder and the second hydrogen pump cylinder.

11. The cryogenic pump of claim 10, further comprising:
a first junction located within the cylindrical insulated vacuum jacket and fluidically connecting the supply header portion with a first supply feed line which is in fluid communication with the first hydrogen pump cylinder, and fluidically connecting the supply header portion with a second supply feed line which is in fluid communication with the second hydrogen pump cylinder; and
a second junction located within the cylindrical insulated vacuum jacket and fluidically connecting the discharge header portion with the first hydrogen pump cylinder through a first discharge line, and fluidically connecting the discharge header portion with the second hydrogen pump cylinder through a second discharge line.

12. The cryogenic pump of claim 11, wherein the first discharge line and the second discharge line are crossed at a crossing location within the cylindrical insulated vacuum jacket whereat the first hydrogen pump cylinder and the second hydrogen pump cylinder are located between the crossing location and the cold end portion base plate.

13. The cryogenic pump of claim 12, wherein:
the first hydrogen pump cylinder has a first cylinder head;
the second hydrogen pump cylinder has a second cylinder head;
the first supply feed line is in fluid communication with the first hydrogen pump cylinder through the first cylinder head;
the first discharge line is in fluid communication with the first hydrogen pump cylinder through the first cylinder head;
the second supply feed line is in fluid communication with the second hydrogen pump cylinder through the second cylinder head; and
the second discharge line is in fluid communication with the second hydrogen pump cylinder through the second cylinder head.

14. The cryogenic pump of claim 13, wherein:
a first inlet check valve is located within the first cylinder head;
the first inlet check valve includes a poppet seat made from a metal material and a seal made from a polymer; and
the first supply feed line is in fluid communication with the first hydrogen pump cylinder through the first inlet check valve.

15. The cryogenic pump of claim 14, wherein at least a portion of the supply header portion within the cylindrical insulated vacuum jacket is formed from flex piping.

16. The cryogenic pump of claim 15, wherein the cryogenic pump is a second stage cryogenic pump.
